(19) United States
(12) Patent Application Publication
(10) Pub. No.: US 2012/0203696 A1
(43) Pub. Date: Aug. 9, 2012

(54) SYSTEMS AND METHODS FOR FACILITATING SECURE TRANSACTIONS

(75) Inventors: Robert E. Morgan, Peoria, AZ (US); Hitesh Seth, East Windsor, NJ (US)

(73) Assignee: American Express Travel Related Services Company, Inc., New York, NY (US)

(21) Appl. No.: 13/024,541

(22) Filed: Feb. 10, 2011

Related U.S. Application Data
(63) Continuation of application No. 13/023,915, filed on Feb. 9, 2011.

(51) Int. Cl. G06Q 40/00

(52) U.S. Cl. 705/44

(57) ABSTRACT

A system for secure transactions receives an authorization request from a mobile device, the mobile device having received the authorization request by scanning a QR code and/or other encoded data. The system processes the authorization request using one or more transaction accounts that are paired to the mobile device, and transmits a response indicating approval or denial of the authorization request.

### CROSS REFERENCE TO RELATED APPLICATIONS

This application is a continuation of, claims priority to and the benefit of, U.S. Ser. No. 13/023,915 filed on Feb. 9, 2011 and entitled “SYSTEMS AND METHODS FOR FACILITATING SECURE TRANSACTIONS,” which is incorporated by reference herein in its entirety.

### BACKGROUND

1. Field of the Invention

The present disclosure generally relates to secure transactions.

2. Related Art

Online shopping (or e-commerce) accounts for a significant percentage of total retail sales in the United States. Moreover, e-commerce retail transactions have steadily gained popularity over the preceding decade. For example, the Census Bureau of the U.S. Department of Commerce estimates that e-commerce retail sales for the second quarter of 2010 totaled approximately $39.7 billion. See U.S. Census Bureau, Quarterly Retail E-Commerce Sales 2^{nd} Quarter 2010, Aug. 17, 2010. The Census Bureau further estimates that in the period beginning with the first quarter of 2001 and ending with the second quarter of 2010, retail e-commerce sales increased, as a percentage of total retail sales, by approximately 3.8 percent. Id.

Concurrently, the United States Department of Justice (“DOJ”) recently concluded (based on a national survey by the Federal Trade Commission) that 10 million people were victims of identity theft and identity fraud during the course of a single year. See U.S. Department of Justice website, Justice Resource Update, Resources for Fighting Identity Theft, Regina B. Schofield, Spring 2006. The DOJ further reports that identity theft related crimes cost victims $5 billion in out-of-pocket expenses, while costs to financial institutions/payment processors approached $48 billion. Id.

Identity theft and identity fraud are serious threats to the continuing viability of electronic commerce. Indeed, the Identity Theft Resource Center recently reported, based on a survey of “500 respondents who had used the internet for banking or purchasing during the previous 30 days,” that 87% of respondents were concerned about the safety of the “personal identifying and financial information they transmit[ted].” See Identity Theft Resource Center, ITRC Consumer Internet Transaction Concerns Survey, Aug. 13, 2010. To be sure, 80% of respondents were concerned with having their passwords stolen, while 78% were concerned with having their usernames stolen. Id. The survey further concluded that 73% of respondents would stop shopping at an online website if a breach occurred at that website. Id. Moreover, 68% of respondents said that they would tell their friends about a breach at a banking or e-commerce website. Id.

Thus, e-commerce transactions comprise a significant and rising proportion of retail transactions in the United States, and these transactions are targeted and attacked by criminals engaged in identity theft and identity fraud. Further, consumers are typically aware of the growing danger, and clearly, many are increasingly hesitant to make purchases online, particularly after experiencing an identity theft attack. The electronic marketplace has grown slowly, but steadily, over the last decade and yet has failed to reach what may be its true potential due to fear by consumers of, among other dangers, identity theft and identity fraud.

As a concrete example of the tremendous potential for fraud, consider current e-commerce systems. These systems typically include a “proceed to checkout” button, which is presented by way of a user interface and which takes a consumer to a merchant's transaction processing forms and system. That is, clicking on a proceed to checkout button generally invokes a webpage containing a form or forms for entering credit card or banking account information, as well as shipping, billing, and email addresses. A merchant accepts all of a customer's personal information in order to facilitate the transaction. Specifically, the merchant must provide the customer's payment processor (e.g., American Express) with detail sufficient to verify that the transaction account supplied by the customer in fact belongs to the customer. However, after supplying all of this personal information to a merchant, a customer loses control over what is ultimately done with his or her personal and financial information. Many merchants, although not deliberately malicious, sell the personal information they collect to third parties, who may, at a minimum, use the data to target unwanted and bothersome advertisements (i.e., spam) to the customer. In other instances, a criminal who wishes to defraud an individual of her personal information may establish a false store front website. Thus, when a consumer attempts to make a purchase, she is prompted for all of her personal information. Having received enough information to persuade the consumer's payment processor that the requested transaction is valid, the criminal may use the consumer's transaction account and identity information in any manner she pleases. Thus, prior art systems expose consumers to identity fraud and identity theft in a variety of ways, some more insidious than others.

There are certain prior art systems that accept encoded data (e.g., a gift card amount) in barcode format. A consumer's mobile device may display an encoded gift card, and a merchant may scan the barcode displayed on the consumer's mobile device using a barcode reader to process the transaction. In these systems, a barcode is displayed on the mobile device, and the transaction is processed in the normal fashion—i.e., through the merchant. Although these systems may give the appearance of safety, in fact, nothing or little has changed. The merchant is still an intermediary to payment, and a consumer's personal data is exposed to, and through, the merchant and the merchant's systems.

Therefore, what is needed is a more secure e-commerce solution. Specifically, a solution that permits secure and carefree online shopping is needed. With such a system in place, consumers will no longer feel the fear that they presently feel prior to conducting an online transaction. Moreover, consumers will experience greater protection, and the incidence of identity theft and identity fraud may dwindle. Under the umbrella of such a system, the electronic marketplace may finally realize its full potential.

### SUMMARY

The present disclosure includes a system, method, and computer program product for secure purchasing. The system receives an authorization request from one or more mobile devices, the mobile device having acquired the authorization request. The system process the authorization request using one or more transaction accounts that are paired to the one or more mobile devices, and transmit an authorization response indicating approval or denial of the authorization request.

Thus, the present disclosure ensures the security of a consumer's personal data and account data by transferring partial or full control over a transaction away from a merchant's payment processing systems and to a transaction account issuer's payment processing systems. Specifically, the consumer's mobile device may communicate an authorization request to the consumer's payment processor, which may handle the details of the transaction. The merchant may receive payment via the consumer's payment processor/transaction account issuer, and may display a payment confirmation to the consumer, in response to completion of the transaction. Thus, the systems and methods described herein enable the partial or full transfer of a payment processing role, traditionally performed by merchants, to a transaction account issuer.

### BRIEF DESCRIPTION OF THE DRAWINGS

The features and advantages of the present disclosure will become more apparent from the detailed description set forth below when taken in conjunction with the drawings, wherein like numbers refer to like elements.

FIG. 1 shows an exemplary system diagram, in accordance with an embodiment.

FIG. 2A shows a flowchart depicting an exemplary method for conducting a secure transaction, in accordance with an embodiment.

FIG. 2B shows a flowchart depicting an exemplary method for conducting a secure transaction, in accordance with an embodiment.

FIG. 3 shows a flowchart depicting an exemplary method for configuring a mobile device to facilitate a secure transaction, in accordance with an embodiment.

FIG. 4 shows a flowchart depicting an exemplary method for social networking an targeted marketing, in accordance with an embodiment.

FIG. 5 shows a flowchart depicting an exemplary method for configuring a mobile device to facilitate travel activity, in accordance with an embodiment.

FIG. 6 shows an exemplary method for registering a coupon-less offer to a transaction account, in accordance with an embodiment.

FIG. 7 shows an exemplary method for suspending and removing a transaction to a web-client, in accordance with an exemplary embodiment.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “financial institution,” “transaction account issuer,” and “payment processor” may include any person, entity, software and/or hardware that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to an “item” may include any good, service, information, experience, reward, points, coupons, credits or anything of value.

Phrases and terms similar to “business”, “merchant”, “supplier” or “seller” may be used interchangeably with each other and shall mean any person, entity, distributor system, software and/or hardware that is a provider, broker and/or any other entity in the distribution chain of goods or services and/or that receives payment or other consideration. For example, a merchant may be a grocery store, a retail store, a travel agency, a service provider, an on-line merchant or the like. For example, a supplier may request payment for items sold to a buyer who holds an account with a transaction account issuer.

The terms “payment vehicle,” “financial transaction instrument,” “transaction instrument” and/or the plural form of these terms may be used interchangeably throughout to refer to a financial instrument. As used herein, an account code may or may not be associated with a physical financial instrument. Further, an account code may or may not be associated with an electronic wallet account, or e-wallet account. Further still, an account code may not be visible to any person or party. That is, an account code may be encoded and/or encrypted in a QR code or other encoded data, as described more fully below.

Phrases and terms similar to a “buyer,” “consumer,” and “user” may include any person, entity, software and/or hardware that receives goods or services in exchange for consideration (e.g. financial payment). For example, a buyer may purchase, lease, rent, barter or otherwise obtain goods from a supplier and pay the supplier using a transaction account.

Phrases similar to a “processor” (such as a payment processor) may include a company (e.g., a third party) appointed (e.g., by a merchant) to handle transactions for merchant banks. Processors may be broken down into two types: front-end and back-end. Front-end processors have connections to various transaction accounts and supply authorization and settlement services to the merchant banks' merchants. Back-end processors accept settlements from front-end processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider that authorizes payments for e-businesses, online retailers, and/or traditional brick and mortar merchants. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to “transaction account” may include any account that may be used to facilitate a financial transaction—e.g., a credit based transaction account, a bank account, an e-wallet account, and the like. A “transaction account” as used herein refers to an account associated with an open account or a closed account system (as described herein). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

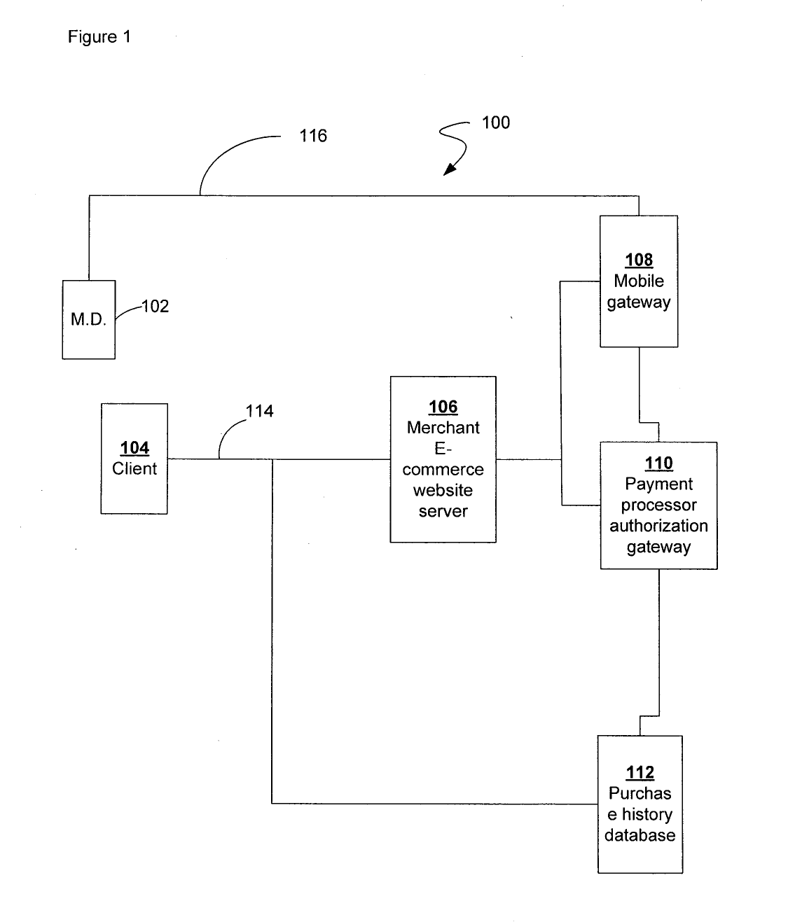

It should be noted that the transfer of information in accordance with the present disclosure, may be completed in a format recognizable by a merchant system or account issuer. In that regard, by way of example, the information may be transmitted from an RFID device to an RFID reader or from the RFID reader to the merchant system in magnetic stripe or multi-track magnetic stripe format. 100371 With reference to FIG. 1, system 100 implements a secure transaction method (described below). System 100 may include a mobile device 102, a client 104, a merchant electronic commerce website server 106, a mobile gateway 108, a payment processor authorization gateway 110, and a purchase history database 112, all or some of which may be coupled via one or more networks 114 and 116.

Mobile device 102 may comprise any hardware and/or software capable of sending and receiving data and/or acquiring an image. A mobile device may include a personal digital assistant (“PDA”), a telephone/cell phone, a smart phone, a camera, a peripheral and/or any other device for acquiring and/or sending data. In an embodiment, a mobile device 102 may communicate with and/or comprise a peripheral device, such as, for example, a pair of spectacles that include a camera and/or scanner capable of acquiring an image. The peripheral device may transmit data to and/or from the mobile device 102 in any suitable manner (e.g., via Bluetooth®).

Client 104 may comprise a personal computer, iPad, iMAC, MacBook, a kiosk, a terminal, a point of sale (POS) device, a television, or any other device capable of receiving data over a network. In an embodiment, client 104 may run Microsoft Internet Explorer, Mozilla Firefox, Google Chrome, Apple Safari, or any other of the myriad software packages available for browsing the internet.

Merchant electronic commerce website server 106 may comprise any type of computer server configured or configurable to host an e-commerce website. Typically, such a server comprises a rack mountable server appliance running a suitable server operating system (e.g., IIS) and having database software (e.g., Oracle) installed thereon. In certain embodiments, electronic commerce website server 106 may include a more generalized computer server 106.

Mobile gateway 108 may comprise any type of computer server configured or configurable to receive data over a network. Typically, such a server comprises a rack mountable server appliance running a suitable server operating system (e.g., IIS) and having database software (e.g., Oracle) installed thereon.

Payment processor authorization gateway 110 may comprise any type of computer server configured or configurable to receive data over a network and process transactions. Typically, such a server comprises a rack mountable server appliance running a suitable server operating system (e.g., IIS) and having database software (e.g., Oracle) installed thereon.

Purchase history database 112 may comprise any type of computer server configured or configurable to host a database. Typically, such a server comprises a rack mountable server appliance running a suitable server operating system (e.g., IIS) and having database software (e.g., Oracle) installed thereon.

Network 114 may comprise any of a variety of network types, including a “cloud” architecture like the internet, a proprietary network, or a combination of both. Network 116 may comprise any of a variety of network types, including an RF network such as a network associated with a wireless provider (e.g, a 3G or 4G network), or even a Wi-Fi network.

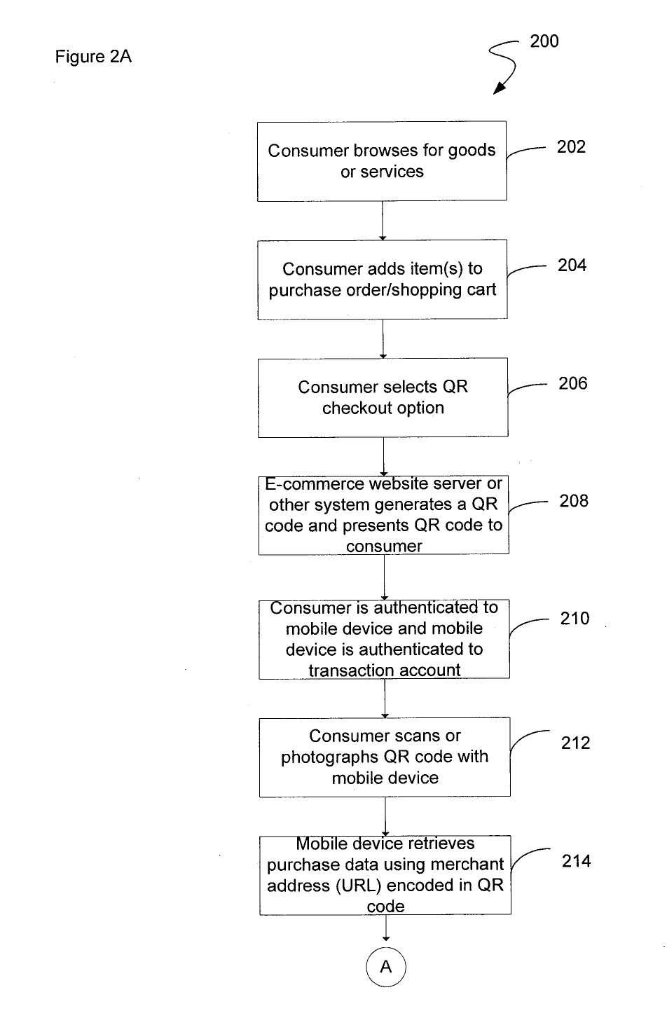

With reference to FIGS. 2A and 2B, a secure transaction process (200) may comprise browsing for an item. Frequently, a consumer may browse for an item by way of a merchant's website or webpage (step 202). Where this is the case, merchant electronic commerce website server 106 may provide a merchant electronic commerce (“e-commerce”) website (not shown), which may be displayed by client 104. If a consumer locates an item she wishes to purchase, she may select the item by way of a graphical user interface (GUI) (step 204). Often, merchants provide an “add to cart” button for this purpose. A consumer may add as many items to her web-based “cart” as she would like to purchase.

In other cases, a consumer may browse for an item in a more traditional fashion. For example, a consumer may peruse the aisles of a merchant's brick and mortar store, adding one or more items to her (physical) shopping cart. In yet another embodiment, a consumer may simply locate in the physical world, or by way of a media interface, an item she desires to purchase, or a bill that she wishes to pay. Thus, a variety of outlets exist for the provision of items. The systems and methods described herein may be applied to each.

Irrespective, however, of the outlets through which a consumer may shop, a transaction may be facilitated by presentation of a Quick Response (QR) code. QR codes are known in the art and may be encoded with a variety of data, including text and uniform resource locators (URLs). In one embodiment, QR codes may contain up to 4,000 bytes of data—i.e., 4,000 characters. The data encoded in a QR code may also be encrypted. In different embodiments, a QR code may be encoded with a variety of data (as further described below).

In addition to QR codes, secure transactions may be facilitated through other forms of encoded data. For example, data may be encoded on a radio frequency (RF) carrier, or in a bar code. A consumer is presented with encoded data, because a QR code (and more broadly, encoded data) comprises a transition point. While a QR code may be used in various examples, any encoded data may instead be used in the various embodiments. A unique QR code may be associated with a particular transaction. As used herein, “unique” may include substantially unique which may comprise infrequently repeating. Moreover, the phrase “QR code” as used herein, may include any encoded data.

One or more groups of unique QR codes may be associated with a group or groups of transactions. In this way, the potential for fraud may be minimized or reduced. For example, where each transaction is associated with a unique QR code, the difficulty associated with forging or generating a fraudulent QR code is greater. Thus, individuals who would commit transaction fraud by presenting to a consumer a fraudulent/forged QR code will encounter some difficulty in receiving payment based upon the fraudulent QR code, as a code may never be recycled (or only very infrequently recycled).

A QR code may reduce or eliminate the need for traditional prior art payment methods. In particular, a QR code may permit a consumer to partially or fully bypass or circumvent merchant payment processing systems entirely. Additionally, as will be described in greater detail below, a QR code is not necessarily presented by a mobile device, but scanned by a mobile device. Thus, the present disclosure illustrates systems and methods that may be considered the reverse of current systems, which continue to needlessly and dangerously rely upon merchants to facilitate payment.

A QR code may be presented to a consumer by way of a variety of mechanisms or channels and/or in association with a variety of items. For instance, client 104 or electronic commerce website server 106 may generate and/or present to a consumer a QR code (step 208) in response to the consumer selecting a “QR Checkout” option in her browser (step 206). In another embodiment, a QR code may be displayed (step 208) by a client 106 comprising a point of sale (POS) device located in a traditional brick and mortar store location. In yet another embodiment, a QR code, bar code, etc. may be presented (step 208) to a consumer in the form of a hanging tag or a sticker affixed to an item or displayed together with an image or description of an item (not shown). In this embodiment, a variety of items may be associated with a consumer's transaction account and/or added to a virtual shopping cart by scanning the codes associated with the variety of hanging tags or stickers. However, all or any subset of the items in the consumer's shopping cart (and/or associated with the consumer's transaction account) may be processed and paid for in the manner described herein. In another embodiment, a QR code may be presented (step 208) to a consumer in association with a billing statement or a travel itinerary. Further still, a QR code may be presented (step 208) to a consumer in association with a taxicab or taxi driver. As practitioners will appreciate, these examples are merely illustrative of the versatility inherent in the various secure purchasing systems and methods described herein.

Where client 104 or electronic commerce website server 106 generate a QR code, computer code (e.g. JavaScript code) running either on client 104 or electronic commerce website server 106 may be implemented to generate the QR code. A QR code may also be generated by an application programming interface (API) called from the system, which may be implemented in a variety of programming languages. In some embodiments, e-commerce website server 106 may, instead of or in addition to a QR code, generate and present to the consumer a bar code or any other form of encoded stripe, shape, or signal that is known in the art or that may become available in the future.

Where a consumer shops (step 204) at a brick and mortar store location, the consumer may checkout (step 206) at a register. In this example, however, rather than swiping her credit or bank card, providing cash, or writing a check, the consumer may be presented with a QR code (step 108) by a client 104 comprising a POS device located on the merchant's premises. The QR code may be presented to the consumer automatically, or it may be presented only on request by the consumer (steps 206 and 208). The QR code may be generated on the POS device 104 or on a backend server 106 coupled to the POS device. As practitioners will appreciate, the QR code may be generated by any software capable of running on a backend server (e.g., PHP) or on a POS device.

Irrespective of the source of the QR code (i.e., merchant e-commerce website server 106, client 104, etc.), in an exemplary embodiment, the consumer authenticates herself to her mobile device 102 (step 210). The authentication may be prior to requesting authorization of a purchase. A consumer may use a password or other security code or mechanism (e.g., voice recognition or other biometric identification) to authenticate her identity. This ensures that the device is not stolen or being used by an unauthorized individual. A consumer may authenticate her identity using a built in feature of the mobile device 102, and/or the consumer may download an application to her mobile device 102 that enables authentication of her identity.

In an exemplary embodiment, a consumer's mobile device authenticates itself to at least one of the consumer's transaction accounts (step 210). Such authentication may occur after the consumer has authenticated herself to her mobile device 102. This exemplary order of operations ensures that the consumer's transaction account cannot be hijacked by an unwanted or unauthorized individual. In other words, in one embodiment, the mobile device 102 will refuse to authenticate itself to one of the consumer's transaction accounts until the consumer has authenticated herself to her device 102.

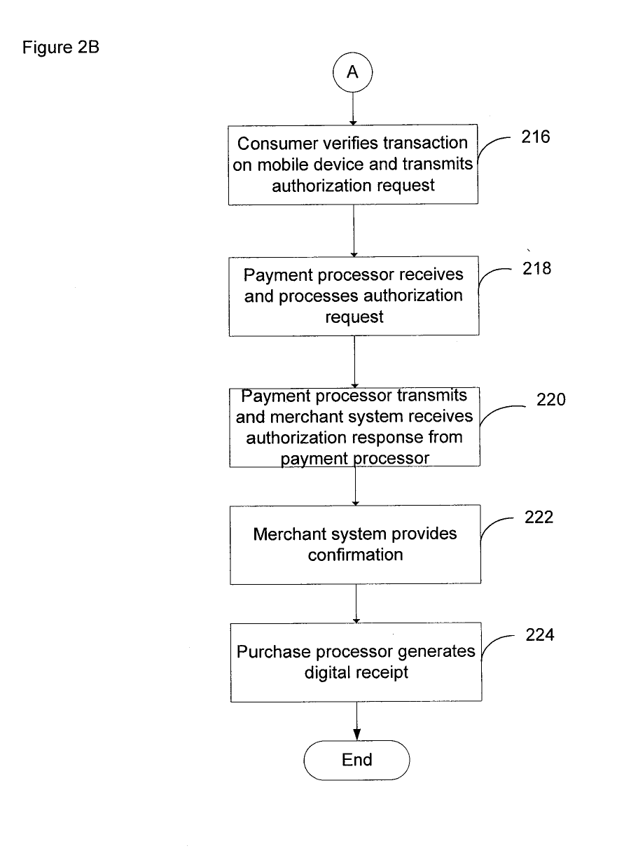

Mobile device 102 may authenticate itself to a consumer's transaction account by way of mobile gateway 108 and payment processor authorization gateway 110. For example, in an embodiment, mobile device 102 may communicate a variety of data to mobile gateway 108, including a mobile device 102 identifier, such as an electronic serial number (ESN), and a transaction account identifier (e.g., a 16 digit account number). Mobile gateway 108 may forward data, including the ESN and transaction account identifier, from mobile device 102 to payment processor authorization gateway 110. Payment processor authorization gateway 110 may authenticate mobile device 102 to one or more transaction accounts held by the consumer by verifying that the mobile device 102 is paired to a selected transaction account. To verify that a mobile device 102 is paired to a transaction account, payment processor authorization gateway 110 may verify that a transaction account identifier (e.g., a transaction account 16 digit number) and the ESN supplied by mobile device 102 match a data record maintained by payment processor authorization gateway 110. That is, payment processor authorization gateway 110 may compare a received transaction account identifier and mobile device 102 identifier to verified records maintained by the gateway 110 or in a database (not shown) coupled to the gateway 110. Verified records are established during a pairing process, which is described below with reference to FIG. 3.

In another embodiment, mobile device 102 may not supply a transaction account identifier to mobile gateway 108. Rather, mobile gateway 108 or payment processor authorization server 110 may, by way of mobile gateway 108, transmit paired transaction account data to mobile device 102, in response to a request by mobile device 102 for such data. Thus, in this example, mobile device 102 first transmits to mobile gateway 108 a mobile device identifier, such as an ESN. On receipt of the ESN or other identifier, payment processor authorization gateway 110 may look up or retrieve one or more transaction accounts that are paired to the mobile device 102. At least one of these paired transaction accounts (or an identifier associated therewith) may be transmitted, by way of mobile gateway 108, to mobile device 102. Mobile device 102 may be used by a consumer to select one of the paired transaction accounts. The selected transaction account may be identified to mobile gateway 108 and payment processor authorization gateway 110.

Thus, a user may select a payment method (i.e., a transaction account) by a variety of means. First, as described above, a user may select a transaction account using her mobile device 102, after which point payment processor authorization gateway 110 may authenticate the mobile device 102 to the selected transaction account. Second, a user may select a transaction account that is already authenticated by payment processor authorization gateway 110 and which the gateway 110 provides to mobile device 102 for selection. In either event, the present system permits a user to treat her mobile device 102 as an electronic wallet, or “e-wallet,” which she may use as a replacement for a traditional wallet—i.e., a wallet that contains a variety of credit cards. Thus, the present system greatly simplifies the traditional purchasing process. Using an e-wallet, consumers will no longer be required to dig through their personal possessions (e.g., their purses and wallets) to locate the credit card they wish to use to make a purchase. Rather, a consumer may simply select a transaction account using her mobile device 102. No further action, or very little action, on the consumer's part is necessary.

In certain embodiments, security may be improved by encrypting transaction account data and/or mobile device identification information. Encryption may be performed by way of any of the techniques now available in the art or which may become available—e.g., Twofish, RSA, El Gamal, Schorr signature, DSA, PGP, PKI, and symmetric and asymmetric cryptosystems.

In an embodiment, the two stage authentication and transaction account selection process described above (step 210) is followed by scanning a QR code (step 212). In certain embodiments, however, a QR code may be scanned by mobile device 102 prior to engaging or completing the two stage authentication and transaction account selection process, or during any part of the process.

A consumer may scan a QR code (step 212) using her mobile device 102. The consumer's mobile device 102 may scan or acquire the QR code using any technology (e.g., imaging) that is presently available or that may become available in the future. Specifically, however, the consumer's mobile device 102 may scan the QR code using a camera built into the mobile device; that is, the mobile device 102 may take a picture or photograph of the QR code. In other embodiments, the merchant electronic commerce website server 106 may be configured to transmit data corresponding to data encoded in a QR code (e.g., unencoded data or data encoded in a different format) to mobile device 102 using a signal. The signal may be a Wi-Fi or radio frequency (RF) signal, a Bluetooth® signal, an infrared signal, an optical signal, or any other signal now available in the art or which may become available in the future. In an embodiment, a peripheral in communication with a user's mobile device 102 (e.g., a pair of spectacles fitted with a digital camera) may take a picture or photograph of the QR code and transmit the QR code or data associated with the QR code to the mobile device 102.

In an exemplary embodiment, merchant electronic commerce website server 106 may transmit data corresponding to data encoded in a QR code (e.g., unencoded data or data encoded in a different format) to the consumer's mobile device 102 using a wired connection, such as USB, Firewire, or the like. Further, where client 104 is a POS device, the POS device or a server coupled thereto may transmit, using any of the mechanisms described above, data corresponding to data encoded in a QR code to the mobile device 102.

In certain embodiments, the QR code may be encrypted. Encryption may be performed by way of any of the myriad techniques now available in the art or which may become available—e.g., Twofish, RSA, El Gamal, Schorr signature, DSA, PGP, PKI, and symmetric and asymmetric cryptosystems.

A consumer's mobile device 102 may retrieve and display the consumer's shopping cart or purchase data using an address and/or pointer (e.g., a URL) associated with a merchant server 106 or a merchant's e-commerce website 106 (step 214). The address/pointer may be delivered to the mobile device 102 by way of a QR code. Specifically, an address/pointer associated with the consumer's shopping cart or purchase data may be encoded in a QR code that is presented to a consumer. A consumer's mobile device 102 may decode the QR code to retrieve the address/pointer, and using an internet connection, the mobile device 102 may retrieve purchase data from the merchant's e-commerce website server 106. Thus, a consumer may view her purchase data or shopping cart with her mobile device 102.

In certain embodiments, practitioners should note that the consumer's mobile device 102 may not decode a QR code. Rather, mobile device 102 may transmit a QR code (e.g., a photograph or other data) to mobile gateway 108. Mobile gateway 108 may decode the QR code, or it may forward the QR code to payment processor authorization gateway 110 for decoding. In either case, decoded data may be returned to mobile device 102, whereupon mobile device 102 may retrieve purchase or shopping cart data using an address associated with a merchant's e-commerce website server 106. In some embodiments, step 214 is not implemented.

Where client 104 is a POS device, mobile device 102 may retrieve and display the consumer's shopping cart or purchase data in a manner similar to that described above. For instance, mobile device 102 may decode the QR code displayed by the POS device to retrieve an address/pointer (e.g., a URL). Using the address/pointer and an internet connection, mobile device 102 may retrieve the consumer's purchase data from a website or web-server associated with a merchant, e.g., a merchant e-commerce website server 106. In certain embodiments, step 214 may be skipped, in which case, mobile device 102 does not display the consumer's purchase data or shopping cart. Thus, in an embodiment, a QR code may not include the contents of a consumer's shopping cart, but a pointer (e.g., a URL) to a database or other data server (e.g., a merchant e-commerce website server 106) that contains, saves, or otherwise holds a consumer's shopping cart data.

Where a consumer's mobile device 102 is configured to decode a QR code, this may be accomplished using an application installed on the mobile device 102. The application may access a decoding library stored on the mobile device 102 to decode the information encoded in the QR code. The application (e.g., payment processor authorization gateway 110) may decode one or more addresses/URLs, as well as a variety of other information encoded in the QR code. For instance, line item detail regarding the items or services the consumer is purchasing may be encoded in the QR code. A variety of other data may be encoded in the QR code. Where data associated with a QR code is encrypted, mobile device 102, mobile gateway 108, and/or payment processor authorization gateway 110 may decrypt the data.

In an exemplary embodiment, a consumer may verify that she wishes to complete her transaction after reviewing her purchase data or shopping cart (step 216). In exemplary embodiments, a consumer may simply verify that she wishes to complete her transaction without reviewing her purchase data or shopping cart. In some embodiments, a consumer may initiate this stage of the checkout process by way of a “verify,” “submit,” “buy,” or “checkout” option presented on a display portion of a mobile device 102. Any other mechanism for indicating a desire to finalize the transaction is also within the scope of this disclosure, however.

In response to verification that a consumer wishes to complete a transaction, a consumer's mobile device 102 may transmit an authorization request to the consumer's payment processor (step 218). Specifically, mobile device 102 may transmit via a wireless network 116 (e.g., a cellular or other wireless network) an authorization request to mobile gateway 108.

An authorization request may include a selected payment method (i.e., a transaction account identifier), as well as billing and shipping information, and an address (e.g., a URL) associated with a merchant's e-commerce server 106. The address or URL associated with a merchant's e-commerce website server 106 may be encoded by a merchant in a QR code and conveyed thereby to payment processor authorization gateway 110. In various embodiments, an authorization request may contain more or less data than the data described above.

Mobile gateway 108 is at least configured to receive an authorization request. Mobile gateway 108 may also be configured to communicate over the network 114 or 116 with mobile device 102. That is, mobile gateway 108 may be configured to transmit and receive data over one or more networks 114 and 116. In response to receiving an authorization request, mobile gateway 108 may forward the authorization request to a payment processor authorization gateway 110, which may be coupled to mobile gateway 108 by way of network 114.

Payment processor authorization gateway 110 may process an authorization request (step 218). Payment processor authorization gateway 110 may further transmit an authorization response to a merchant's e-commerce website server 106 (or another merchant system 106, step 220) by way of an address or URL associated with the merchant's server 106. An authorization response may indicate approval or denial of an authorization request and may be based on a variety of factors and/or data, many associated with the internal business logic of a payment processor (for example, a payment processor may decline an authorization request where a transaction account is associated with insufficient funds).

In another embodiment, payment processor authorization gateway 110 may transmit an authorization response to a consumer's mobile device 102 (step 220), in which case payment processor authorization gateway 110 may or may not also transmit an authorization response to a merchant's e-commerce website server 106 (or other merchant server system 106). In an embodiment where client 104 is a POS device, payment processor authorization gateway 110 may transmit a response to a server 106 that is coupled to the POS device (step 220). Payment processor authorization gateway 110 may additionally transmit an email to an email address associated with a consumer indicating approval or denial of a consumer's authorization request. Gateway 110 may also transmit an electronic or other message (e.g., SMS text message) to a consumer indicating approval or denial of a consumer's authorization request.

A merchant's e-commerce website server 106 or another merchant server system 106 may receive a response transmitted by payment processor authorization gateway 110 (step 220). If payment processor authorization gateway 110 approves a transaction, a merchant may provide a confirmation page via its website, indicating to a consumer that a transaction was successful (step 222). A merchant server system 106 may also transmit an email, SMS text message, and the like to a consumer showing that a transaction was successful. In the event that payment processor authorization gateway 110 does not approve a transaction, a merchant may provide a webpage (update the existing page, pop-up or other notification) indicating that a transaction was unsuccessful. Such a webpage may request that a consumer retry a purchase using her mobile device 102, or select by way of her mobile device 102 a different payment processor, a different transaction account, or both.

Where client 104 comprises a POS device, the device may perform in a manner similar to that described above. Specifically, the POS device may provide a confirmation message to a consumer indicating that a transaction was successful or unsuccessful (step 222). The POS device, or a server coupled to the device, may also transmit an email, SMS text message, and the like to a consumer indicating, among other things, whether an authorization request was approved or denied. The POS device may also request that a consumer select a different payment processor, a different transaction account, or both.

In an exemplary embodiment, payment processor authorization gateway 110 may generate a digital receipt showing the details of a purchase (step 224). A digital receipt may be generated whether the purchase order is successful or unsuccessful, and it may be associated with a consumer's transaction account. A digital receipt may also be saved by payment processor authorization gateway 110 to purchase history database 112 and/or to a database (not shown) hosted by mobile gateway 108. Purchase history database 112 may be coupled by way of a wired or wireless connection to network 114 and may provide information to client 104 and/or mobile device 102 regarding a consumer's current and previous purchases/transactions. Thus, in an embodiment, purchase history database 112 may provide one or more digital receipts (e.g., a list of digital receipts) to authorization gateway 110, which may, in turn, provide the one or more digital receipts to merchant electronic commerce website server 106 or to mobile gateway 108. In either event, purchase history information may be conveyed by way of networks 114 and/or 116 to a consumer's client 104 or to a consumer's mobile device 102. In yet another exemplary embodiment, purchase history database 112 may provide one or more digital receipts to client 104 over network 114 (which comprises, e.g., an internet connection). Where client 104 is a POS device, the purchase history information may be transmitted to a server 106 coupled to the device, which may display the purchase history via the POS device.

Turning to FIG. 3, an exemplary method for configuring a consumer's mobile device 102 to facilitate online purchasing is shown (300). That is, in an embodiment, a consumer's mobile device 102 may require the installation of an application or application software before it is capable of interfacing with system 100. To this end, a consumer may download an application or application software to her mobile device 102 (step 302). Application software may be downloaded by any of the mechanisms now available in the art or which may in the future become available. For instance, application software may be downloaded by way of a third party application provider (e.g., the Apple® Application Store). Application software may be downloaded from a payment processor's support center or website (not shown). In any event, such software may be downloaded using a wired or wireless connection (e.g., networks 114 and or 116).

As part of a mobile device initialization process, in an embodiment, a consumer authenticates herself to her mobile device 102 (step 304). To authenticate herself to her mobile device 102, a consumer may utilize a built in feature of the mobile device 102 (e.g., password protection), or the consumer may download an application to her mobile device 102 that enables authentication of the consumer to her mobile device 102. In either case, the consumer is authenticated to her mobile device 102 as part of an initialization process.

Various authentication methods are known in the art, and all are within the scope of the present disclosure. For example, the present disclosure contemplates, but is not limited to, password protection and voice recognition and other biometric identification methods (e.g., fingerprint recognition, heartbeat recognition, DNA analysis, retinal scans and the like). In an embodiment, a consumer may be authenticated based upon her physical/geographic location (see below for additional detail). For example, a consumer who makes a purchase in New Jersey on a particular day during a particular time may not be authenticated where that consumer attempts (or appears to attempt) to make a second or additional purchase in a physical/geographic location (e.g., California) on the same day and at a time that would preclude her having traveled to that location.

Further, where a consumer is authenticated to her mobile device 102 by way of an application installed on her mobile device 102, a consumer may be prompted to set up an authentication code, such as a password, which may be used to “unlock” the mobile device 102 prior to making a purchase. An initialization process may also provide a consumer with an opportunity to establish default shipping and billing addresses, as well as a default payment method (e.g., a default transaction account). Thus, as described above with reference to FIGS. 1 and 2A and 2B, a consumer may omit the step of entering payment and billing and shipping information prior to making a purchase. Rather, the consumer may rely on defaults entered during setup or initialization.

Authorization gateway 110 may associate, or “pair,” one or more mobile devices 102 with at least one of a consumer's transaction accounts (step 306). In an embodiment, a mobile device 102 may only need to be paired to a transaction account once, on initialization of application software, after which point payment processor authorization gateway 110 may have a record associating a consumer's transaction account or accounts with the consumer's mobile device 102. The mobile device may be permanently or semi-permanently (or even temporarily) associated with the consumer's transaction account or accounts using a unique identifier associated with the mobile device 102, such as an electronic serial number (“ESN”) assigned to the mobile device 102 or even a telephone number associated with the mobile device 102. In this way, mobile device 102 is “paired” with a consumer's transaction account or accounts.

In another embodiment, a mobile device 102 that is paired to one or more transaction accounts may be paired, at a later date, to a non-paired account. For example, a consumer may acquire a new credit card or transaction account after she has paired one or more of her existing accounts to her mobile device 102. In this event, a consumer may use application software (described above) to pair the new or un-paired account to mobile device 102. The process for pairing the account to mobile device 102 is substantially similar to the process described above. That is, a consumer may be required to authenticate herself to her mobile device (step 304). Thereafter, a consumer may be required to authenticate herself to her new or desired transaction account (step 306). On completion of this two-stage authentication process, a consumer's transaction account may be paired to her mobile device 102.

Just as setup may be required prior to using a mobile device 102 with system 100, a merchant may also need to configure its systems (e.g., its server 106, POS devices, etc.) to interact with system 100. Specifically, a merchant may need to configure its e-commerce website server 106 to generate QR codes. A merchant may also need to configure its POS devices, or backend servers 106 coupled to its POS devices, to generate QR codes. A merchant may use any method known in the art or which may become known for this purpose. For instance, a merchant may add some client side code to a webpage hosted by its e-commerce website server 106 that generates QR codes on client 104. This code may be in a variety of languages, as described below (e.g., JavaScript). A merchant may configure a merchant electronic commerce website server 106 to generate QR codes on a computer server (“server-side”). This may be accomplished using a variety of software, as described below (e.g., PHP). Where the client 104 is a POS device, a merchant may generate a QR code on a computer server 106, or it may install a software application that generates QR codes its POS devices.

### Embodiments

A variety of specific embodiments are described below. These embodiments are not to be construed as limiting the scope of the present invention. Rather, each embodiment described below is merely illustrative of a particular implementation of the broader systems and methods described above.

### Automatic Bill Payment

In an exemplary embodiment, a purchasing process (200) may comprise presenting a QR code to a consumer by way of a billing statement. In this embodiment, the purchasing process described above is generally implemented, with the exception that a QR code is presented by way of a periodic billing statement (step 208). A periodic billing statement may comprise a paper billing statement or an electronic billing statement, such as a monthly billing statement provided by a gas or electric company. As described above, a consumer may pay her bill using her mobile device 102 and a transaction account paired thereto (steps 210-224).

Here, however, a consumer may arrange to have her mobile device 102 notify her periodically that her bill is scheduled to come due. For example, after a consumer pays a periodic bill using the systems and methods described above, she may arrange for her mobile device 102 to generate an automatic reminder that her bill is or will be due within an interval. The consumer may elect to pay her bill in response to the reminder, and her mobile device 102 may simply pay the bill using one or more transaction accounts that are paired to the device 102. Thus, the bill paying process is greatly simplified by virtue of a consumer's mobile device 102, which, again, may track the consumer's billing cycles, issue reminders, and permit one-touch or touch-less bill payment and management.

### Location-Based Fraud Prevention and Merchandise Allocation

In an exemplary embodiment, a purchasing process (200) may comprise a location-based aspect for the detection and prevention of fraud. Broadly, the purchasing process described above is supplemented by a current location of mobile device 102. So, for example, a consumer may attempt to use her mobile device 102 to make a purchase in the manner described above. Here, however, a consumer's authorization request (step 216) may include a current location of mobile device 102. The authorization request may further include a timestamp associated with the current location of the mobile device 102. Payment processor authorization gateway 110 may generate an authorization response (steps 218 and 220) based at least upon the current location.

Thus, for instance, payment processor authorization gateway 110 may compare a current location of mobile device 102 to a previous location of mobile device 102, where the previous location is associated with a prior authorization request by mobile device 102. If a previous location is distant from a current location (e.g., if a threshold distance is exceeded), payment processor authorization gateway 110 may generate an authorization response denying the authorization request. Hence, payment processor authorization gateway 110 may prevent fraudulent activity that occurs as a result of a lost, stolen, or spoofed transaction account or mobile device 102. Payment processor authorization gateway 110 may also prevent an identity thief from attempting to use a stolen transaction account or mobile device 102 in multiple locations in rapid or frequent succession. This may be accomplished based upon a current location of mobile device 102, a previous location of mobile device 102, and a timestamp associated with each location. In an embodiment, and where a transaction account is paired to more than one mobile device 102, payment processor authorization gateway 110 may authorize an authorization request in a location that triggers a denial.

In another embodiment, a merchant may register an item with payment processor authorization gateway 110 in order to reduce an inventory of the good. For example, a merchant that is having difficulty selling Sony Playstations® may register these products with payment processor authorization gateway 110. Payment processor authorization gateway 110, in turn, may offer to a consumer who scans a QR code associated with a registered product (e.g., a Sony Playstation®) an option to purchase the registered product from a different merchant or from a same merchant at a different merchant location. Payment processor authorization gateway 110 may limit such offers to consumers in a geographic range of the merchant that registered that registered the good. In a comparable embodiment, rather than making an offer to a consumer, payment processor authorization gateway 110 may notify a merchant affiliated with the merchant that registered the good (e.g., another store location) of the offer. Thus, affiliated merchants may use the present systems and methods to collectively manage their inventories. For instance, a merchant location that is not offering a discount on a selected product may nonetheless notify a consumer in its store location that an affiliated merchant, perhaps several miles away, is offering a discount on the selected product.

The location of a mobile device 102 may be determined based upon a global positioning system (GPS) receiver built into the mobile device 102. In the event that a mobile device 102 is not equipped with a GPS receiver, the location of the mobile device 102 may be determined by triangulating (or partially triangulating) the position of the mobile device 102 relative to at least one cellular base station. Finally, in an embodiment, a user must authorize her participation in the location-based methods and systems described above.

### Taxi Checkout

In another embodiment, a purchasing process (200) may comprise presenting a QR code to a consumer in a taxicab. Such a QR code may encode information associated with the driver or proprietor of a taxicab. In certain embodiments, a QR code may be updated dynamically by way of an electronic display, such as a liquid crystal display (LCD) housed within a taxicab. In this case, a QR code may be encoded with a fare total. In other embodiments, a QR code may be static and displayed on a tag or sticker affixed to an inside surface of a taxicab. In this case, a QR code may not be encoded with a fare total. However, a consumer may simply enter a fare total (plus tip) in her mobile device 102 after scanning the static or dynamic QR code.

A taxi driver may receive, in this or a similar embodiment, a message via her mobile device 102 that indicates that a fare has been paid (step 220). Accordingly, a consumer may interact with a taxi driver without paying cash, thereby improving the safety (physical and financial) of the taxi driver as well as the safety of the consumer.

### Social Networking and Targeted Marketing

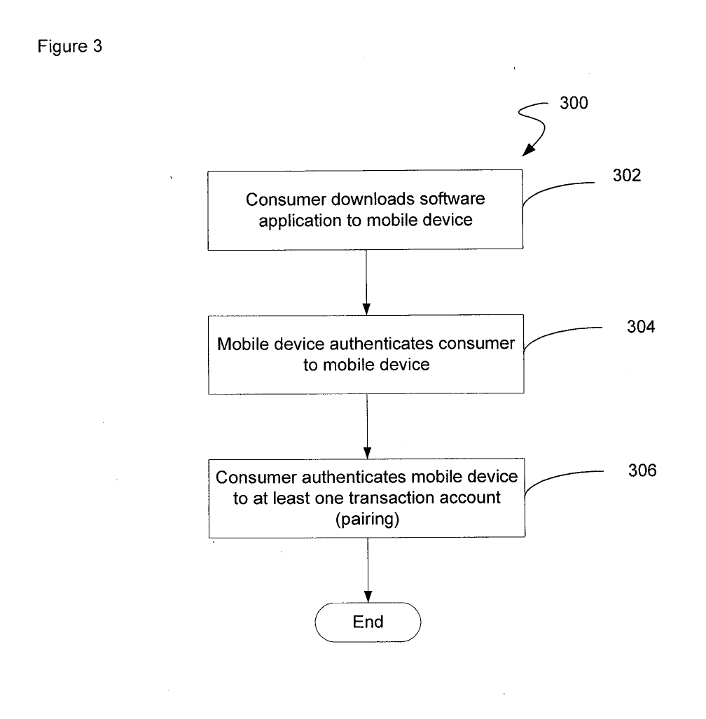

In another embodiment, and with reference now to FIG. 4, the systems and methods described above may include a social networking and/or a targeted marketing aspect (process 400). For example, payment processor authorization gateway 110 may update a user profile associated with a consumer in response to an authorization request by a consumer (step 402). Specifically, an authorization request may include line item or product data associated with an item that the consumer desires to purchase. The item may be associated with one or more industry segments. Thus, the consumer's user profile may be updated to reflect that she is interested in goods or services grouped in an industry segment associated with her recent authorization request.

Payment processor authorization gateway 110 may transmit an offer to a member of the consumer's social network who has a user profile similar to the consumer's user profile (step 404). For example, a consumer may include her mother as a member of her social network, and the consumer's mother may have a user profile similar to the consumer's user profile, as both women are interested in similar products and services (e.g., coffee). Payment processor authorization gateway 110 may therefore generate an offer for the consumer's mother relating to a coffee product. The offer may appear on the mother's mobile device 102, and the mother may purchase the coffee product using her mobile device by way of a transaction account that is paired to her mobile device 102 (steps 216-224).

Further, payment processor authorization gateway may generate and send a particular offer to a member of a consumer's social network on a particular date or during a particular range of dates. For instance, payment processor authorization gateway 110 may generate and transmit an offer to a member of a social network on a birthday, or payment processor authorization gateway 110 may generate and transmit an offer to a member of a social network on or around a holiday. Although it may be advantageous to generate an offer around a birthday or holiday, this is not required. To be sure, payment processor authorization gateway 110 may generate an offer at any time.

Similarly, payment processor authorization gateway 110 may generate and transmit an offer to a consumer (as opposed to a member of the consumer's social network) (step 406). This may occur on a particular date or within a particular range of dates (e.g., a birthday or a holiday), and may be based upon the consumer's user profile, although this is not required. Thus, for example, if a consumer's user profile suggests that the user is interested in art supplies, payment processor authorization gateway may generate and transmit an offer for one or more art supplies to the consumer.

### Enhanced Travel

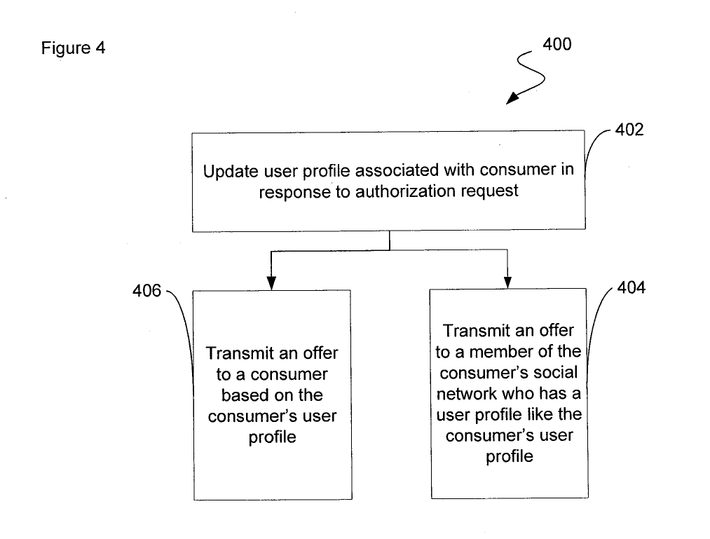

In another embodiment, and with reference to FIG. 5, the systems and methods described above may be supplemented or adapted for travel (process 500). Process 500 may comprise presenting a QR code to a consumer by way of a travel itinerary or a travel ticket (step 502). The travel itinerary or travel ticket may be printed on paper or displayed electronically. Such a QR code may be encoded with a user's travel itinerary or aspects thereof, e.g., the consumer's various destinations and times of departure and arrival. Payment processor authorization gateway 110 may generate offers and suggestions for the consumer based upon her itinerary (step 504). For example, payment processor authorization gateway 110 may suggest a merchant (e.g., a hotel) to a consumer when the consumer's itinerary takes the consumer (or will take the consumer) near the merchant. Relatedly, a consumer may scan her travel itinerary into her mobile device 102 in order to disable or preempt a fraud hold that might be placed on one or more of her transaction accounts absent such activity (step 506) (see above with reference to the embodiment entitled “Location-Based Fraud Prevention”).

Here, it is worth noting that the consumer does not initially make a purchase, nor send an authorization request, by way of her mobile device 102 (although this may occur as a later result of a merchant suggestion). Rather, and apart from many of the embodiments heretofore described, the consumer first uses her mobile device 102 in combination with a QR code to add “intelligence” to her mobile device 102. Thus, the present disclosure permits a consumer to use her mobile device 102 as an intelligent e-wallet (see above). That is, the consumer's e-wallet (comprising her mobile device 102 paired to one or more transaction accounts) may facilitate other activities besides purchasing (e.g., travel).

### Offer Registration

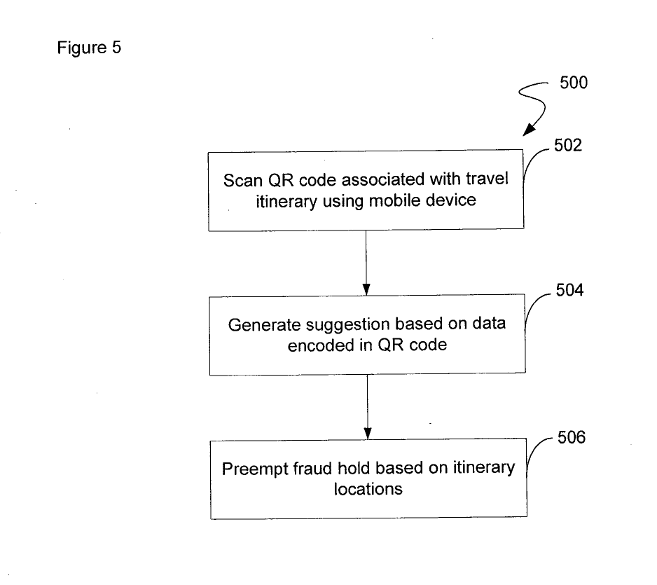

In another embodiment, and with reference to FIG. 6, a consumer may use her mobile device 102 to scan a QR code that enables registration of a transaction account paired to her mobile device 102 for a discount or “couponless offer” (process 600). Traditionally, such offers are reserved for customers of a particular payment processor (e.g., American Express), and are made available via the internet. For example, a payment processor may offer its customers 10% off of purchases made at a Staples® store. In traditional systems, a payment processor customer must register via a complicated and time consuming process in order to receive a couponless offer. With the present embodiment, a consumer may simply scan a QR code to register for a couponless offer, after which point the customer's paired transaction account or accounts may be registered to receive the offer.

The consumer may scan the QR code by way of a payment processor's website, or by way of a merchant's website or at a merchant's store location (step 602). For example, a consumer may visit a Staples® store, where there may be provided a sign or a plurality of signs displaying one or more QR codes for different discounts associated with different products and/or payment processors. A consumer may scan with her mobile device 102 one or more QR codes depending upon which payment processor(s) the consumer has accounts with and/or would like to use to make a purchase in Staples®. The consumer may also scan a QR code corresponding to a product or a group of products that the consumer is interested in purchasing. In response to the QR code or QR codes, payment processor authorization gateway 110 may register one or more of the consumer's transaction accounts (that are paired to the mobile device) to receive the offer associated with each of the QR codes.

A consumer may interact with the merchant (e.g., Staples®) to complete a purchase in the manner and using the systems and methods described above. Specifically, the consumer may submit an authorization request by way of her mobile device 102 (step 216). The authorization request may include a couponless offer, although this may not be required, as the consumer's transaction account(s) may be associated with the offer through the registration process.

### Customer Loyalty

In another embodiment, the systems and methods described above may assist in providing rewards to customers to encourage customer loyalty. For instance, a payment processor (e.g., American Express) may leverage its closed-loop proprietary customer databases to offer incentives and rewards to customers who match certain criteria. Specifically, in an embodiment, a payment processor may apply a promotion to a transaction associated with an authorization request provided by a mobile device 102. The promotion may be applied immediately (e.g., at a client 104 or POS device 104), as well as on a billing statement. Further, an authorization request may be evaluated by payment processor authorization gateway 110 based upon the promotion. A promotion may be based upon a type of transaction account as well as upon a status of a transaction account. Example types of transaction accounts include: Gold, Platinum, Titanium, and Blue card transaction accounts. Examples of a status of a transaction account include: overdue, reconciled, no available credit, inactive, active, and settled.

A payment processor may also retrieve a promotion from a third party. For instance, a third party may be registered to offer promotions through system 100. System 100 may match a promotion offered by a registered third party with an authorization request initiated by a transaction account holder. That is, a transaction account holder may generate an authorization request via her mobile device 102. Payment processor authorization gateway 110 may receive the authorization request and, based upon a promotion offered for the transaction account holder by a registered third party, payment processor authorization gateway 110 may apply the promotion to the requested transaction. This may occur before or after the authorization request is authorized. Additional detail relating to third party offers is described in U.S. patent application Ser. No. 12/857,389, filed Aug. 16, 2010, which is hereby incorporated by reference. Third party offers are also described in U.S. patent application Ser. No. 12/857,424, filed Aug. 16, 2010, which is hereby incorporated by reference.

A payment processor may also optionally credit loyalty points to a consumer based upon a transaction processed through a consumer's mobile device 102. Likewise, a consumer may elect to redeem loyalty points, which may have monetary value, to reduce the price of a transaction through her mobile device 102. Additional information relating to customer loyalty is described in U.S. patent application Ser. No. 12/847,832, filed Jul. 30, 2010, which is hereby incorporated by reference.

### Merchant Exception Handling

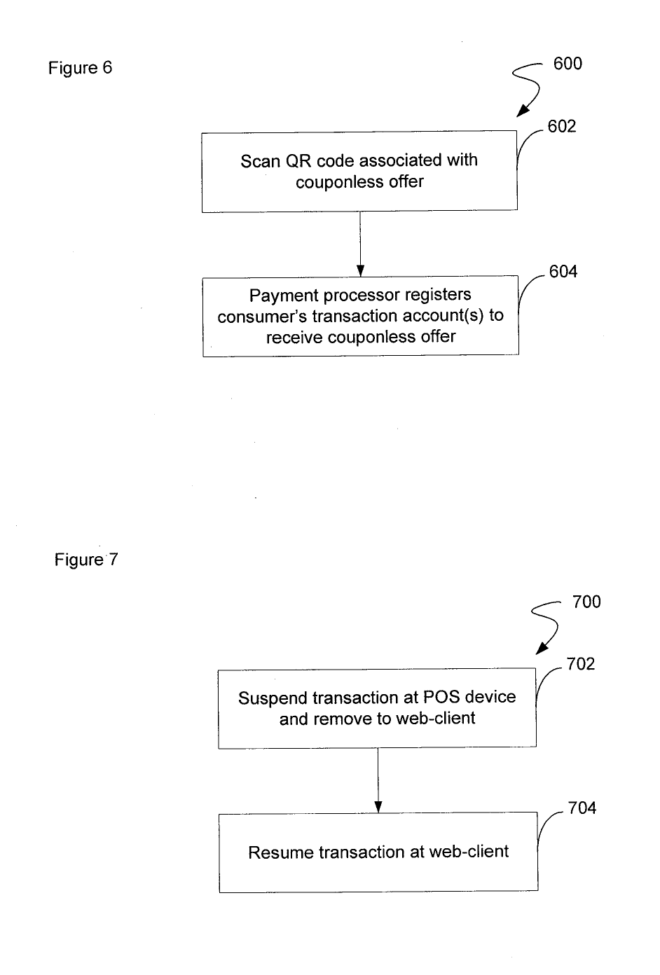

In another embodiment, and with reference now to FIG. 7, purchasing process (200) may include a merchant “exception handling” aspect (process 700). For example, many merchant POS systems are equipped with a “suspend transaction/resume transaction” feature that permits removal of a pending transaction to a different register in response to, for example, a broken POS device, an inoperative cash register, or a spill or broken object in a cashier lane. This feature, or a similar feature, may facilitate removal of a pending transaction, not to a different register, but to an “exception handling” system comprising a client 104 enabled to resume a partially processed transaction (steps 702 and 704). Client 104 may display a QR code, which a consumer may scan using her mobile device 102 (see process 200). Thus, a consumer who loses or leaves behind her credit card may, for example, remove her transaction in a merchant location to a client 104 housed in the merchant location and enabled to facilitate a transaction by way of the systems and methods described herein.

### Television Based Shopping

In an embodiment, and where client 104 comprises a television (see above), a consumer may scan or photograph a QR code or other encoded data displayed on or by the television. Thus, for example, a consumer may see an item displayed by an actor or actress on television (e.g., the actor/actress may hold an item having a QR code printed on its surface). A consumer wishing to add the item to her shopping cart and/or purchase the item, may scan or photograph a QR code/other encoded data associated with the item. The QR code/other encoded data may be printed upon the item or displayed by a television in association with the item (e.g., in a corner of the display/screen).

The terms “computer program medium” and “computer usable medium” are used to generally refer to media such as removable storage drives, hard disks, and signals. These computer program products provide software to computer system 100. The disclosure is directed to such computer program products.

Computer programs (also referred to as computer control logic) are stored in memory. Such computer programs, when executed, enable the computer system 100 to perform the features of the present invention, as discussed herein. In particular, the computer programs, when executed, enable a processor to perform the features of the present invention. Accordingly, such computer programs represent controllers of the computer system 100.

In an embodiment where the invention is implemented using software, the software may be stored in a computer program product and loaded into computer system 200 using a removable storage drive, hard drive, or communications interface associated therewith. The control logic (software), when executed by a processor, causes the processor to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software. The architecture of the present invention is sufficiently flexible and configurable, such that it may be utilized (and navigated) in ways other than that shown in the accompanying figures.

Systems, methods and computer program products for fraud prevention and implementing fraud prevention tools are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in certain embodiments.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a non-transitory computer readable medium and/or memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; credit bureau data, third party data, financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 200 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewalls may include any hardware and/or software suitably configured to protect

CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, Visa Net® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

Moreover, where a phrase similar to “at least one of A, B, and C” or “at least one of

A, B, or C” is used in the claims or the specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the herein-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a computer-based system for secure transactions, an identifier associated with a mobile device;
authenticating, by the computer-based system, a user of the mobile device to a transaction account;
pairing, by the computer-based system, the mobile device to the transaction account based upon the identifier.

2. The method of claim 1, wherein the identifier is an electronic serial number (ESN).

3. The method of claim 1, further comprising transmitting, by the computer-based system, an application to the mobile device that enables at least one of: authentication of the mobile device to the transaction account and authentication of the user of the mobile device to the transaction account.

4. The method of claim 1, further comprising authenticating, by computer-based system, the user of the mobile device to the mobile device prior to pairing the mobile device to the transaction account.

5. The method of claim 1, further comprising receiving, by the computer-based system, an authorization request from the mobile device, wherein the authorization request includes data that is based upon a quick response (QR) code, and wherein the mobile device acquires the QR code.

6. The method of claim 5, further comprising authenticating, by the computer-based system, the user of the mobile device to the mobile device prior to authorizing the authorization request.

7. The method of claim 5, further comprising authorizing, by the computer-based system, the authorization request based upon the transaction account that is paired to the mobile device.

8. The method of claim 5, further comprising authenticating, by the computer-based system, the mobile device to the transaction account prior to authorizing the authorization request.

9. The method of claim 5, further comprising transmitting, by the computer-based system, an authorization response to the mobile device.

10. The method of claim 5, further comprising transmitting, by the computer-based system, an authorization response to an email address associated with the user of the mobile device.

11. The method of claim 1, further comprising authenticating, by the computer-based system, the user of the mobile device to a second transaction account and pairing the mobile device to the second transaction account based upon the identifier.

12. The method of claim 11 further comprising:
receiving, by the computer-based system, an authorization request from the mobile device, wherein the authorization request includes data that is based upon a quick response (QR) code, and wherein the mobile device acquires the QR code; and
authorizing, by the computer-based system, the authorization request based upon the second transaction account that is paired to the mobile device.

13. The method of claim 11, further comprising receiving, by the computer-based system, a selection of one of the transaction account and the second transaction account.

14. The method of claim 1, further comprising receiving, by the computer-based system, at least one of: a payment method, a billing address, and a shipping address.

15. The method of claim 14, further comprising pairing, by the computer-based system, at least one of: the payment method, the billing address, and the shipping address to the mobile device.

16. The method of claim 6, further comprising saving, by the computer-based system, a digital receipt associated with the authorization request.

17. The method of claim 16, further comprising transmitting, by the computer-based system, the digital receipt to the mobile device.

18. The method of claim 16, further comprising transmitting, by the computer-based system, a list of digital receipts to the mobile device.

19. An article of manufacture including a non-transitory, tangible computer readable medium having instructions stored thereon that, in response to execution by a computer-based system for secure transactions, cause the computer-based system to perform operations comprising:
receiving, by the computer-based system, an identifier associated with a mobile device;
authenticating, by the computer-based system, a user of the mobile device to a transaction account;
pairing, by the computer-based system, the mobile device to the transaction account based upon the identifier.

20. A system comprising:
a tangible, non-transitory memory communicating with a processor for secure transactions,
the tangible, non-transitory memory having instructions stored thereon that, in response to execution by the processor, cause the processor to perform operations comprising:
receiving, by the processor, an identifier associated with a mobile device;
authenticating, by the processor, a user of the mobile device to a transaction account;
pairing, by the processor, the mobile device to the transaction account based upon the identifier.
